(19) United States
(12) Patent Application Publication
(10) Pub. No.: US 2008/0142141 A1
(43) Pub. Date: Jun. 19, 2008

(54) Pneumatic Tire

(75) Inventor: Hideaki Takahashi, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd., Osaka (JP)

(21) Appl. No.: 11/956,517

(22) Filed: Dec. 14, 2007

(30) Foreign Application Priority Data
Dec. 19, 2006 (JP) 2006-340879

(51) Int. Cl. B60C 5/14

(52) U.S. Cl. 152/510

(57) ABSTRACT

A pneumatic tire having an inner liner includes a specified rubber compound on the inner surface of the tire, maintaining air retainability and improved with road noises without deteriorating a rolling resistance or a durability, in which the ratio (E′r/E′p) of the dynamic modulus of elasticity E′r in the axial direction of the tire and the dynamic modulus of elasticity E′p in the peripheral direction of the tire of an inner liner rubber sampled from the tire is 1.1 or more.

### BACKGROUND OF THE INVENTION

1. Field of the Invention

The present invention concerns a pneumatic tire and, more specifically, a pneumatic tire improved with load noises by providing an anisotropy to a tire rigidity by an inner liner from the inner surface of the tire.

2. Description of the Related Art

For decreasing road noises of a tire, particularly, road noises in a high frequency region of 250 Hz or higher, it is effective to constrain a portion as a starting site for the amplitude of vibrations in the radial direction of the tire and it includes, for example, a method of locating a highly rigid member to the portion, or increasing the rigidity of a carcass ply, or increase the loss of a tread rubber, but each of the method has a drawback that the rolling resistance is worsened.

Heretofore, for the inner liner of a pneumatic tire, a rubber compound using a rubber ingredient of low air permeability such as butyl rubber or halogenated butyl rubber is used in order to prevent air leakage of the tire and keep the pneumatic pressure constant, but no technical examples directly mention about the inner liner regarding the improvement of the road noises.

For example, as an existent example for decreasing the road noises by actuation from the inner surface of a tire, Japanese Patent Application Kokai No. 6-40206 describes that a foamed rubber layer at a relatively low foaming ratio is disposed to the inner bore surface of an inner liner thereby decreasing the peak sounds of road noises generated near 260 Hz and making the noises uniform in each of frequencies.

Further, Japanese Patent Application Kokai No. 11-189017 describes a technique of decreasing low frequency road noises in a range from 80 to 160 Hz without worsening the driving stability by disposing a sound absorbing rubber sheet layer with a tangent δ of from 0.2 to 0.7 at 20° C. between a carcass and a inner liner on a side wall.

The techniques in the literatures described above concern an improvement for the road noises by a foamed rubber layer or a sound absorbing rubber sheet layer added to the inner liner but the inner liner has no direct concerns with the road noises.

### BRIEF SUMMARY OF THE INVENTION

The invention has been achieved in view of the foregoing situations and intends to provide a pneumatic tire improved with road noises, particularly, road noises in a high frequency region of 250 Hz or higher while keeping air retainability without deteriorating the rolling resistance or the durability by providing an inner liner with a difference of rigidity between the axial direction and the peripheral direction of the tire.

As a result of an earnest study for solving the subject described above, the present inventor has accomplished the invention on the basis of a knowledge that a rigidity in the axial direction of tire can be maintained at a high level from the inner surface of the tire by providing the inner liner of the pneumatic tire with anisotropy, that is, by providing a high rigidity along the axial direction and a low rigidity along the peripheral direction of the tire. Further, the inventor has found that the anisotropy of the inner liner can be improved without deteriorating the air retainability of the inner liner by compounding syndiotactic-1,2-polybutadiene by a predetermined amount as a rubber compound for use in the inner liner.

That is, the invention provides, in a first aspect, a pneumatic tire having a inner liner on the inner surface of the tire in which the ratio (E′r/E′p) of the dynamic modulus of elasticity (E′r) in the axial direction of a tire and the dynamic modulus elasticity E′p in the peripheral direction of the tire of the inner liner rubber sampled from the tire is 1.1 or more.

The pneumatic tire of the invention comprises, in a second aspect, a rubber compound containing 0.3 phr by weight or more and 3.0 phr by weight or less of syndiotactic-1,2-polybutadiene based on 100 phr by weight of a rubber ingredient comprising 40 phr by weight or more of a butyl rubber and/or a halogenated rubber and a dienic rubber and can be obtained by rolling the rubber compound to a predetermined thickness and using the same as the inner liner, and arranging the grain direction of the inner liner along the axial direction of the tire.

### BRIEF DESCRIPTION OF THE DRAWINGS

FIG. 1 is a cross sectional view for one-half part of a pneumatic tire of an embodiment of the invention; and

FIG. 2 is a cross sectional view for an inversed L-shaped calendar.

### DETAILED DESCRIPTION OF THE INVENTION

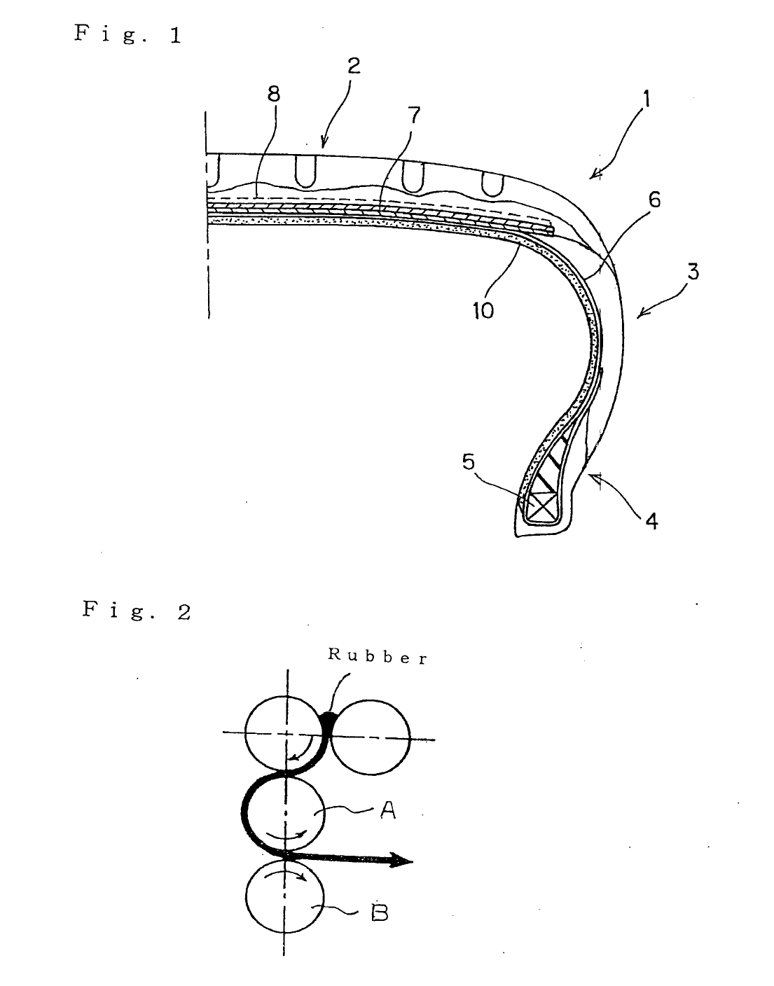

Embodiments of the invention are to be described. FIG. 1 is a cross sectional view for one-half part of a pneumatic tire 1 according to an embodiment of the invention, and the embodiment shows an example applied to a radial tire for a passenger car.

The pneumatic tire 1 has a carcass 6 comprising a sheet of a carcass ply using organic fiber cords made of a polyester or the like and engaged to the periphery of bead cores 5 buried to a pair of beads 4 respectively by being turned-back from the inside to the outside of the tire, a tread 2 situated to the outer periphery of a crown of the carcass 6, a side wall 3 situated on the side of the carcass 6, a belt 7 comprising two sheets of belt plies using steel cords disposed between the inside of the tread 2 and the carcass 6, and a cap ply 8 comprising nylon cords spirally wound in the peripheral direction of the tire to the outer periphery of the belt 7.

An inner liner 10 is located while covering the tread 2, the side wall 3, and the bead 4 on the inner peripheral surface of the tire and retains a pneumatic pressure of the tire 1 when the tire 1 is assembled to a rim and filled with an inner pressure.

In the embodiment of the invention, a rubber compound used for the inner liner 10 uses, as a rubber ingredient, 40 phr by weight or more of a butyl rubber (IIR) and/or a halogenated butyl rubber (X-IIR) having a low gas permeation coefficient and a dienic rubber.

Halogen X for X-IIR is not particularly restricted so long as it is a halogen usually used for the rubber ingredient and generally includes chlorine or bromine.

In the rubber for use in the inner liner according to the embodiment of the invention, since IIR when used alone may involve a drawback such as poor adhesion between adjacent rubber, for example, the bead or carcass and the inner liner, or retardation of the vulcanizing speed, use of X-IIR is preferred with a view point of improving them and IIR and X-IIR can be used being compounded at an optional ratio.

For X-IIR described above, chlorobutyl rubber or bromobutyl rubber of various grades available as commercial products from JSR Co., Exxon Co, Bayer AG etc. can be used.

It is necessary that IIR and/or X-IIR is contained by at least 40 phr by weight or more in 100 phr by weight of the rubber ingredient in view of the air retainability and it is preferably 50 phr by weight or more. In a case where the content of IIR and/or X-IIR exceeds 95 phr by weight, adhesion to the adjacent rubber and the fabricatility of the rubber compound tend to be deteriorated.

Further, the dienic rubber includes, for example, natural rubber (NR), isoprene rubber (IR), styrene butadiene rubber (SBR), butadiene rubber (BR), and styrene-isoprene-butadiene rubber (SIBR) and at least one member selected from the group can be used. Particularly, NR, IR, and BR are particularly preferred since they have an effect for improving the adhesion and the vulcanization speed of IIR or X-IIR.

The rubber compound for use in the inner liner according to the embodiment of the invention can be properly compounded with the rubber ingredients described above and compounding agents used usually for the rubber compound for use in the inner liner, for example, reinforcing agents such as carbon black, silica, calcium carbonate, magnesium carbonate, aluminum hydroxide, magnesium hydroxide, alumina, clay, talc, and magnesium oxide, plasticizers such as oils, crosslinking agents, crosslinking aids, and vulcanization promoters such as stearic acid, petroleum resins, sulfur, and zinc powder.

The kind of the carbon black is not particularly restricted and includes, for example, HAF, ISAF, SAF, GPF, and FEF. Among them, those having a nitrogen adsorption specific surface area (N₂SA) of 20 to 80 m²/g, preferably, 25 to 50 m²/g are preferred. The compounding amount of the carbon black is preferably from 20 to 80 phr by weight based on 100 phr by weight of the rubber ingredient. In a case where the compounding amount of the carbon black is less than 20 phr by weight, the reinforcing effect tends to be decreased. In a case where it exceeds 80 phr by weight, the rubber viscosity increases and the fabricability during kneading or rolling tends to be lowered.

The rubber compound can be obtained by kneading using a usual rubber kneading apparatus, for example, a roll, a banbury mixer, or a kneader.

While the method of fabricating the rubber compound into the inner liner is not particularly restricted, it is generally rolled into a sheet-like shape of a predetermined thickness usually by a calendering apparatus having 2 to 4 rubber rolling rolls.

In the inner liner, reinforcing agents such as carbon black, silica, and calcium carbonate, and compounding agents such as zinc powder, stearic acid, and petroleum resins to be compounded with the rubber ingredient are oriented in the grain direction by rolling irrespective of a crystalline state (solid state) or an amorphous state to show anisotropy between the grain direction of the inner liner and the direction perpendicular thereto.

That is, properties such as a tensile strength, elongation, modulus of elasticity, etc. are different between the grain direction of the inner liner and the direction perpendicular thereto and higher values are shown in the grain direction than in the direction perpendicular thereto.

The present inventor has noted on the anisotropy of the inner liner, and provided the anisotropy for the inner liner disposed to the inner surface of the tire between the axial direction and the peripheral direction of the tire disposed to the inner surface of the tire by arranging the grain direction of the inner liner along the axial direction of the tire, thereby increasing the rigidity in the axial direction to more than the rigidity in the peripheral direction of the tire in the side wall to constrain the starting site for amplitude of vibrations situated to the side wall and decreasing the road noises in the high frequency region of 250 Hz or higher.

In the embodiment of the invention, as the index for the difference of the rigidity between the axial direction and the peripheral direction of the tire, an inner liner sampled from the tire is used as a sample, and the rigidity level is quantitized by the dynamic modulus of elasticity E′r of the inner liner rubber measured in the axial direction of the tire and the dynamic modulus of elasticity E′p measured in the peripheral direction of the tire.

Then, the pneumatic tire of the embodiment of the invention has a ratio of the dynamic modulus of elasticity E′ r in the axial direction of the tire and the dynamic modulus of elasticity E′p in the peripheral direction of the tire (E′r/E′p) of 1.1 or more, and a meaningful difference is obtained between the rigidity in the axial direction of the tire and the rigidity in the peripheral direction of the tire from the tire inner surface to thereby decrease the road noises by setting the ratio to 1:1 or more.

The anisotropy provided to the inner liner by the rolling can be controlled, for example, by arrangement of rolls (for example, serial type and L type in three rolls), ratio of roll rotation speed, roll temperature, etc. upon rolling.

Further, the rubber compound for use in the inner liner of the embodiment of the invention can contain from 0.3 phr by weight or more and less than 3.0 phr by weight of syndiotactic-1,2-polybutadiene (hereinafter referred to as syn-1,2-PB) based on 100 phr by weight of a rubber ingredient comprising 40 phr by weight or more of IIR and/or X-IIR and the dienic rubber.

By compounding syn-1,2-PB, the crystalline syn-1,2-PB ingredient can disperse in the rubber ingredient to enhance the rigidity of the rubber compound. Further, by rolling the rubber compound by roll, calendar, etc. syn-1,2-PB is oriented in the grain direction to easily provide the anisotropy to the obtained inner liner.

In a case where the content of the syn-1,2-PB ingredient in the rubber ingredient is less than 0.3 phr by weight, the effect due to the ingredient is not provided, that is, the amount of orientation of syn-1, 2-PB in the inner liner obtained by rolling is small and no intended anisotropy can be obtained sufficiently. Further, in a case where it exceeds 3.0 phr by weight, the syn-1,2-PB ingredient may form obstacles tending to lower the air retainability, and cause cracking of the liner and adhesion destruction to the liner joint during running due to the increase of the rubber hardness. Accordingly, by compounding syn-1,2-PB within a predetermined range to the rubber ingredient, the anisotropy can be developed while ensuring the air retainability of the inner liner.

Syn-1,2-PB described above can be obtained by polymerization methods described, for example, in Japanese Patent Publication Nos. 53-39917, 54-5436, and 56-18005.

Further, for syn-1,2-PB, cis-1,4-polybutadiene rubber modified with syn-1,2-PB can also be utilized.

The cis-1,4-polybutadiene rubber modified with syn-112-PB can be obtained by a method described in Japanese Patent Application Kokai No. 55-31802, that is, a method of polymerizing 1,3-butadiene under the presence of a 1,2-polymerization catalyst in an organic solvent, then adding an organic solvent solution of cis-1,4-polybutadiene rubber to a polymerization solution of syn-1,2-PB obtained by deactivating the catalyst and mixing them under stirring, and separating a mixture of syn-1,2-PB and cis-1,4-polybutadiene rubbers from the mixed solution, or a method described in Japanese Patent Application Kokai No. 5-194658, that is, a method of polymerizing 1,3-budadiene at first without complete transformation under the presence of a 1,4-polymerization catalyst into cis-1,4-polybutadiene and then changing a 1,2-polymerization catalyst to the polymerization system to subject remaining 1,3-butadiene to 1,2-polymerization.

Further, for the cis-1,4-polybutadiene rubber modified with syn-1,2-PB is available as UBEPOL “VCR” trade name of products manufactured by Ube Kosan Co. and “VCR617” can be used for example.

Also in the case of the rubber compound containing syn-1,2-PB, the method of fabricating to the inner liner is not particularly restricted and the rubber compound can be rolled into a sheet of a predetermined thickness by a calendar apparatus having 2 to 4 rolls used for rubber rolling in the same manner as described above.

An inner liner in which the anisotropy develops in the rubber property can be obtained by orienting the syn-1,2-PB ingredient in the rubber ingredient along the grain direction. That is, a high rigidity is provided for the grain direction and a rigidity lower than that in the grain direction is provided in the counter-grain direction.

The pneumatic tire according to the embodiment of the invention can be manufactured by molding and vulcanizing a green tire by a customary method by arranging the grain direction of the inner liner obtained as described above in the axial direction of the tire to obtain a pneumatic tire in which anisotropy is provided between the axial direction and the peripheral direction of the tire and the rigidity in the axial direction is maintained high from the inner surface of the tire.

### EXAMPLE

Embodiments of the present invention are to be described specifically with reference to examples but the invention is not restricted only to such examples. Rubber ingredients and compounding agents used for the examples and the comparative examples are the following materials.

### [Material]

Bromobutyl rubber: bromobutyl 2030 manufactured by Bayer AG
Natural rubber: RSS#3 produced in Thailand
VCR: VCR617 (cis-1,4-polybutadiene ingredient: 83%, syn-1,2-PB ingredient: 17%) manufactured by Ube Industries Ltd.
Carbon black GPF: SEAST V manufactured by Tokai Carbon Co. Ltd.
Aroma oil: JOMO Process X-140 manufactured by Japan Energy Co.
Petroleum resin: Fukkole resin 120 manufactured by Fuji Kosan Co.
Stearic acid: Lunack S-25 manufactured by Kao Corp.
Vulcanization promoter NS: Sanceler NS-G, manufactured by Sanshin Chemical Industry Co.
Vulcanization promoter DM: Sanceler DM-G, manufactured by Sanshin Chemical Industry Co.
Sulfur: powder sulfur, manufactured by Tsurumi Chemical Industry Co.
Zinc powder: zinc oxide class 2, manufactured by Sakai Chemical Industry Co.

In accordance with respective compounding formulations shown in Table 1 (phr by weight), compounding agents other than sulfur, zinc powder, and vulcanization promoter, and rubber ingredient were kneaded by a banbury mixer by a customary method to prepare a master batch. Then, the sulfur, the zinc powder, and the vulcanization promoter were compounded with the master batch and kneaded by a banbury mixer to obtain each of unvulcanized rubber compounds.

The air permeability of each of the obtained rubber compounds was evaluated. Then, the rubber compounds were rolled by an inversed L-shape calendar to manufacture inner liners of 0.5 mm thickness. The inner liners of each of the examples and the comparative examples were improved for the anisotropy of the inner liner by changing the rotational speed ratio (B/A) of the rolls A and B of the inversed L shaped calendar shown in FIG. 2 into the ratio shown in Table 1 to adjust the orientation property of the compounding agent in the rubber compound.

Radial tires having a general structure of size 195/65R15 91H in which the rolling direction (grain direction) of the inner liner was arranged along the axial direction of the tire were manufactured, the dynamic modulus of elasticity in the axial direction and the peripheral direction (E′r, E′p) of the tire for the inner liner rubber sampled from each of the tire were measured to determine the ratio (E′r/E′p). The road noise, the rolling resistance, and the running durability under a low inner pressure for each of the tires were evaluated. The respective test methods are as shown below. The results are shown in Table 1.

### [Air Permeability]

Using the rubber compounds described above, rubber sheets of 1 mm thickness were prepared by press vulcanization at 160° C. for 20 min under a pressure of 50 Kgf/cm², and an air permeability ratio was measured by a differential pressure method (A method) according to JIS K 7126. The ratio was shown by index expression based on 100 of Comparative Example 1 as a reference. The air permeability is lower and more preferred as the value is smaller.

### [Dynamic Modulus of Elasticity]

Inner liner rubber sampled in the radial direction and in the peripheral direction from each of the tires was prepared into a rectangular sample of 0.3 mm thickness×5 mm width×10 mm length, and the dynamic modulus of elasticity E′ was measured for each of the test samples at an initial strain of 10%, a dynamic strain of 5%, a frequency of 15 Hz, and an atmospheric temperature of 23° C. using a dynamic viscoelasticity spectrometer (manufactured by Ueshima Seisakusho Co.).

### [Road Noise]

Each set of four radial tires was conditioned to an air pressure of 200 kPa by using a standard rim according to JIS, mounted on “GOLF IV”, and road noises in a high frequency region (250 Hz or higher) with two persons being aboard were functionally evaluated by three test drivers on a dry road surface for road noise evaluation of a tire test course owned by the applicant. With respect to “±0” for Comparative Example 1 as a reference, it was evaluated and expressed in the table as “+1” in a case of somewhat superior to Comparative Example 1 (level where the meaningful difference of road noise is discernible by a driver but not discernible by an attendant passenger), as “+2” in a case of superior thereto (level discernible also by the attendant passenger), as “−1” for somewhat inferior thereto (a level in which the meaningful difference of the road noise is discernible by the driver but not discernible by the attendant passenger) and as “−2” in a case of inferior thereto (level discernible also by the attendant passenger).

### [Rolling Resistance]

Each of the radial tires was set to a pneumatic pressure of 200 kPa and at a load of 450 kgf using a standard rim according to JIS and a rolling resistance was measured upon running by a 1-shaft drum tester for measuring the rolling resistance at 23° C. and 80 km/h. It was indicated by an index with a value for Comparative Example 1 being assumed as 100. Smaller index shows smaller rolling resistance and, accordingly, excellent fuel cost property.

### [Durability in Low Pressure Running]

After setting each of the radial tires to a pneumatic pressure of 80 kPa and at a load of 350 kgf by using a standard rim according to JIS and, after running by a 1-shaft drum tester for measuring the durability at 23° C. and 40 km/h for 60 min, absence or presence for the occurrence of abnormality at the inner surface such as cracking, breaking, joint opening, etc. of the inner liner was observed. They were evaluated as “acceptable” for those with no abnormality and as “rejected” for those with occurrence of abnormality.

TABLE 1

| | | Comp. | Comp. | Comp. | Comp. | | | | | |
|---|---|---|---|---|---|---|---|---|---|---|
| | | Example 1 | Example 2 | Example 3 | Example 4 | Example 1 | Example 2 | Example 3 | Example 4 | Example 5 |
| Compounding | Bromobutyl rubber | 70 | 70 | 75 | 70 | 70 | 70 | 75 | 75 | 80 |
| ingredient | Natural rubber RSS#3 | 30 | 30 | 24.17 | 9.25 | 30 | 28 | 20 | 12.55 | 5.89 |
| | VCR | 0 | 0 | 1 | 25 | 0 | 2 | 5 | 15 | 17 |
| | cis-1,4-PB | — | — | 0.83 | 20.75 | — | 1.66 | 4.15 | 12.45 | 14.11 |
| | ingredient in VCR | | | | | | | | | |
| | syn-1,2-PB | — | — | 0.17 | 4.25 | — | 0.34 | 0.85 | 2.55 | 2.89 |
| | ingredient in VCR | | | | | | | | | |
| | Carbon black GPF | 45 | 45 | 45 | 45 | 45 | 45 | 45 | 45 | 45 |
| | Aroma oil | 5 | 5 | 5 | 5 | 5 | 5 | 5 | 5 | 5 |
| | Petroleum resin | 12 | 12 | 12 | 12 | 12 | 12 | 12 | 12 | 12 |
| | Stearic acid | 2 | 2 | 2 | 2 | 2 | 2 | 2 | 2 | 2 |
| | Vulcanization | 0.2 | 0.2 | 0.2 | 0.2 | 0.2 | 0.2 | 0.2 | 0.2 | 0.2 |
| | promoter NS | | | | | | | | | |
| | Vulcanization | 1.4 | 1.4 | 1.4 | 0.9 | 1.4 | 1.4 | 1.4 | 1.4 | 1.4 |
| | promoter DM | | | | | | | | | |
| | Sulfur | 0.5 | 0.5 | 0.5 | 0.8 | 0.5 | 0.5 | 0.5 | 0.5 | 0.5 |
| | Zinc powder | 4 | 4 | 4 | 4 | 4 | 4 | 4 | 4 | 4 |
| | Ratio for roll | 1.00 | 1.05 | 1.05 | 1.30 | 1.20 | 1.20 | 1.15 | 1.15 | 1.25 |
| | rotational speed | | | | | | | | | |
| | (B/A) | | | | | | | | | |
| Result | Air permeability | 100 | 100 | 100 | 105 | 100 | 100 | 100 | 100 | 100 |
| | (index) | | | | | | | | | |
| | E′r/E′p | 1.00 | 1.05 | 1.05 | 1.60 | 1.15 | 1.20 | 1.15 | 1.20 | 1.25 |
| | Road noise | ±0 | ±0 | ±0 | +2 | +0.5 | +1 | +0.5 | +1 | +2 |
| | Rolling resistance (index) | 100 | 100 | 100 | 100 | 100 | 100 | 100 | 100 | 100 |
| | Durability in low | acceptable | acceptable | acceptable | rejected | acceptable | acceptable | acceptable | acceptable | acceptable |
| | inner pressure | | | | | | | | | |
| | running | | | | | | | | | |

The tires of Examples 1 to 5 of the invention maintained the rolling resistance and the durability and were improved for the road noises. In Examples 2 to 4 using the rubber compound containing syn-1,2-PB, E′r/E′p could be made equal with or more than that in Example 1 without increasing ratio for the rotational speed of the rolls. In Example 5, it can be seen that E′r/E′p can be increased more and the effect of decreasing the road noise can be obtained more greatly by further increasing the syn-1,2-PB ingredient and increasing the ratio for the rotational speed of the rolls.

On the other hand, it can be seen for Comparative Examples 2, 3 with E′r/E′p of less than 1.1 that the anisotropy effect for the inner liner can not be obtained and there is no difference in the road noise with reference to Comparative Example 1 and for Comparative Example 4 with more compounding amount of syn-1,2-PB that E′r/E′p is large and the road noise is excellent but syn-1,2-PB forms obstacles to worsen the air permeability and the durability and it can no more serve as the inner liner.

According to the pneumatic tire of the embodiment of the invention, by providing the inner liner disposed to the inner surface of the tire with the anisotropy between the axial direction and the peripheral direction of the tire, that is, by increasing the rigidity in the axial direction of the tire to 1.1 or more than the rigidity in the peripheral direction of the tire as the ratio of the dynamic modulus of elasticity in the side wall, a rigidity can be provided at a higher level in the axial direction of the tire from the inner surface of the tire thereby constraining the starting site for the amplitude of vibrations situating to the side wall, decreasing the road noise in the high frequency region of 250 Hz or higher and, as a result, road noises can be improved over low to high frequency regions. The pneumatic tire of the invention can be used suitably for general purpose tires, as well as for tires with the importance being attached to the quietness or high performance tires served for high speed running.

The pneumatic tire of the invention is applicable to tires of various sizes and application uses and it is suitable to tires for use in passenger cars, particularly, tires with importance being attached to quietness, or to higher performance tires used for high speed running.

What is claimed is:

1. A pneumatic tire having an inner liner on the inner surface of the tire in which
a ratio (E′r/E′p) between the dynamic modulus of elasticity E′ r in the axial direction of a tire and the dynamic modulus of elasticity E′p in the peripheral direction of the tire of an inner liner rubber sampled from the tire is 1.1 or more.

2. A pneumatic tire according to claim 1, wherein
the inner liner comprises a rubber compound containing 0.3 phr by weight or more and less than 3.0 phr by weight of syndiotactic-1,2-polybutadiene based on 100 phr by weight of a rubber ingredient comprising 40 phr by weight or more of butyl rubber and/or halogenated butyl rubber and a dienic rubber, the rubber compound is rolled into a predetermined thickness and used for the inner liner, and the grain direction of the inner liner is arranged along the axial direction of the tire.
